(19) United States
(12) Patent Application Publication
(10) Pub. No.: US 2010/0040217 A1
(43) Pub. Date: Feb. 18, 2010

(54) SYSTEM AND METHOD FOR IDENTIFYING AN ACTIVE PARTICIPANT IN A MULTIPLE USER COMMUNICATION SESSION

(75) Inventors: Christopher Aberg, Johanneshov (SE); Anna Stenquist, Stockholm (SE); Henrik Albertsson, Stockholm (SE); Jonas Lundgren, Bromma (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/193,211

(22) Filed: Aug. 18, 2008

(51) Int. Cl. H04M 3/42

(52) U.S. Cl. 379/202.01

(57) ABSTRACT

Participants of a conference call dial in to or are invited to participate in a conference by a central conference calling center. Participant identification information is transmitted from the conference calling center to each of the participants. The participant identification information includes an unique identifier and an address associated with each of the participants of the conference call. Audio signals received at an electronic device are interrogated to identify the participant that originated the audio signals (the active participant). The audio signals and/or a graphical representation of the active participant is output in a predetermined manner based on the identification of the active participant that originated the audio signals.

### TECHNICAL FIELD OF THE INVENTION

The present invention generally relates to conference calling systems, and more specifically relates to a method and system for identifying an active participant in a multiple user communication session (e.g., a conference call).

### BACKGROUND

Mobile and/or wireless electronic devices are becoming increasingly popular. With a mobile work force, mobile telephones have become an indispensable tool for many workers including, for example, professionals, salespersons, etc. Conference calls are a standard method of communication in today's business environment.

### SUMMARY

The present invention generally relates to conference calling systems, and more specifically relates to a method and system for identifying an active participant in a multiple user communication session (e.g., a conference call, video conference call, etc.). One problem with multiple user communication sessions is that when there are a lot of participants participating in a session, it can be extremely difficult to identify the participant that is actually speaking at any given time. Aspects of the present invention relate to identifying an active participant participating in the multi-user communication session and outputting the audio signals and/or graphical representations of the active participant in a predetermined manner based on the identification of the active participant that originated the audio signals.

The predetermined manner may include displaying a graphical representation of the active participant in a form larger than graphical representations of non-active participants of the conference call on a display associated with the electronic device. The graphical representation may include, for example, an image, a picture, a caricature, a cartoon figure, an animated figure, a video, an icon, a text character, etc. The person that is the active participant on the conference call may be represented with a larger graphical representation than the other participants on the conference call. When the person speaking switches from one user to another user, the graphical representation of the person currently speaking automatically is enlarged and the graphical representation of the person previously speaking may be reduced, for example.

The predetermined manner may also include routing audio signals received by the electronic device to an audio output device (e.g., speakers, surround sound speakers, etc.) coupled to the electronic device based on the identification of the active participant that originated the audio signal. For example, an electronic device may have a 5:1 stereo surround speakers coupled to the electronic device. Each member of the multi-user communication session may be assigned to a separate speaker, such that when the active participant is identified, all audio signals that originated from the active participant may be output to a particular speaker. If there are more participants in the session than audio output devices, more than one participant may be assigned to a particular audio output device.

One aspect of the invention relates to a method for identifying an active participant in a multiple participant communication session, the method including: receiving participant identification information for each participant on a multiple participant communication session from a conference calling system to an electronic device, wherein the participant identification information includes an unique identifier and an address associated with each participant; receiving an audio signal from a conference calling system, wherein the audio signal is in a packet form and includes the unique identifier associated with at least one of the plurality of participants that originated the audio signal; identifying an active participant that originated the audio signal based at least in part on a comparison between the unique identifier contained in the audio signal and the participant identification information received from the conference calling system; and outputting the audio signal and/or a graphical representation of the active participant in a predetermined manner based on the identification of the active participant that originated the audio signals.

Another aspect of the invention relates to including processing the received identifier from the audio signal to determine the address associated with the active participant by comparing the received identifier to the received participant identification information.

Another aspect of the invention relates to including retrieving information associated with the active participant stored locally on the electronic device, wherein the information retrieved is associated with the address of the active participant.

Another aspect of the invention relates to displaying a graphical representation of the active participant when the local stored information includes graphical information associated with the active participant.

Another aspect of the invention relates to the step of outputting including displaying the graphical representation of the active participant in a form larger than graphical representations of non-active participants of the conference call on a display associated with the electronic device.

Another aspect of the invention relates to when a new active participant is identified the graphical representation associated with the active participant is reduced in size to correspond in size to graphical representations of non-active participants and the graphical representation of the new active participant is displayed in the form larger than graphical representations of the non-active participants.

Another aspect of the invention relates to including generating a representation of the active participant when local stored information does not include graphical information associated with the active participant.

Another aspect of the invention relates to including displaying identification text on a display of the electronic device when the identification text associated with a participant is stored locally in the electronic device.

Another aspect of the invention relates to the identification text is selected from contact information stored in an electronic phonebook application stored in a memory of the electronic device.

Another aspect of the invention relates to the step of outputting includes outputting the audio signals to an audio output device coupled to the electronic device based on the identification information of the active participant contained in the received the audio signals.

Another aspect of the invention relates to each participant participating in the multiple user communication session is assigned a separate audio output device based on the participant identification information received by the conference calling system.

Another aspect of the invention relates to including receiving an invitation from the conference call center to join the conference call session.

Another aspect of the invention relates to the electronic device transmitting a request to the conference call center to join the conference call session.

Another aspect of the invention relates to the address received in the participation identification information includes at least one from a group consisting of: an electronic mail address, a session initiation protocol (SIP) address, a uniform resource identifier (URI), an E.164 number, a telephone number, a subscriber identification module (SIM) number.

One aspect of the invention relates to an electronic device including: a radio for receiving participant identification information and audio signals from a conference calling center, wherein the participant identification information includes an unique identifier and an address associated with each participant of a multiple participant communication session and the audio signals correspond to at least one participant of the conference call, wherein the audio signals are in a packet form and includes the unique identifier associated with at least one of the participants that originated the audio signals; at least one output device for outputting at least one of a graphical representation or the audio signals to an associated user of the electronic device; and a controller coupled to the radio and the at least one output device, wherein the controller identifies an active participant of the conference call that originated the audio signal from the identification information contained in the audio signals and the controller outputs the at least one of the audio signals and/or the graphical representation of the active participant in a predetermined manner based on the identification of the active participant that originated the audio signals.

Another aspect of the invention relates to a memory coupled to the controller and the at least one output device, wherein the memory includes contact information associated with one or more of the participants, wherein the contact information includes the graphical representation of at least one of the participants.

Another aspect of the invention relates to a display coupled to the controller, wherein the display presents the graphical representation of the active participant in a form larger than non-active participants in the multiple participant communication session.

Another aspect of the invention relates to an audio output device for outputting the audio signals received by the electronic device based on the identification information of the active participant contained in the received the audio signals.

Another aspect of the invention relates to the audio output device including a plurality of speakers, wherein audio signals received from the conference calling system are output to one of the plurality of speakers based on the participant identification information received by the conference calling system and the received audio signals.

One aspect of the invention relates to a method for identifying an active participant in a multiple user communication session, the method including: receiving a signal from each of a plurality of electronic devices, wherein each of the electronic devices is associated with a user desiring to participate in a conference call; generating an unique identifier for each of the plurality of electronic devices; storing an address for each of the plurality of electronic devices based on the received signal associated with each of the plurality of associated users; associating the unique identifier with the address for each of the plurality of electronic devices; establishing a central communication link between a conference calling center and each of the plurality of electronic devices, wherein the communication link includes a control signaling channel and a media signaling channel; distributing participant identification information to each of the plurality of electronic devices, wherein the participant information includes the unique identifier and the address associated with each participant; receiving a media packet from one of the associated users, wherein the media packet includes voice data associated with an active participant; inserting the unique identifier in the media packet, wherein the unique identifier is associated with the active participant; and transmitting the media packet containing the unique identifier to non-active participants of the multiple party communication session, wherein the unique identifier in the packet may be used to identify the active participant.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a block diagram of an exemplary electronic device in accordance with aspects of the present invention.

FIG. 2 is a schematic block diagram of the exemplary electronic device illustrated in FIG. 1.

FIGS. 3 and 4 are exemplary systems in accordance with aspects of the present invention.

FIG. 5 is an exemplary method in accordance with aspects of the present invention.

FIG. 6 is an exemplary computer system that may implement a conference calling center in accordance with aspects of the present invention.

FIG. 7 is an exemplary method in accordance with aspects of the present invention.

FIGS. 8 and 9 are exemplary systems in accordance with aspects of the present invention.

FIGS. 10A-10C are exemplary user displays in accordance with aspects of the present invention.

FIG. 11 is an exemplary system in accordance with aspects of the present invention.

FIGS. 12A-12C are exemplary user displays in accordance with aspects of the present invention.

FIG. 13 is a schematic block diagram of an electronic device utilizing audio isolation to identify an active participant in accordance with aspects of the present invention.

### DETAILED DESCRIPTION OF EMBODIMENTS

Embodiments will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like. Other exemplary electronic devices include, but are not limited to, computers, televisions, media players and gaming devices.

In the present document, embodiments of the system and method are described primarily in the context of a mobile telephone. It will be appreciated, however, that the exemplary context of a mobile telephone is not the only context and the teachings disclosed herein may relate to any type of telephone conferencing system and/or an appropriate electronic device operable to receive from and/or transmit signals to a telephone conferencing system may be used in accordance with aspects of the present invention.

Aspects of the present invention relate to identifying an active participant in a multiple user communication session (e.g., a conference call, video conference call, etc.) and outputting the audio signals and/or a graphical representation associated with the active participant in a predetermined manner. Generally, the participants of the conference call will dial in to a central conference calling center and/or receive a request to join a conference call from the central conference calling center. Participant identification information, which includes a unique identifier and an address associated with each participant, is transmitted from the conference calling center to each of the participants of the session. A participant in the communication session may have an electronic device (e.g., a mobile telephone, a computer or other electronic device) that either displays a graphical representation of one or more participants in a conference call and/or includes a plurality of speakers that may be associated with one or more participants participating in the communication session.

Graphical representation of one or more of the participants may be furnished by the conference calling center and/or stored locally in a memory of the electronic device.

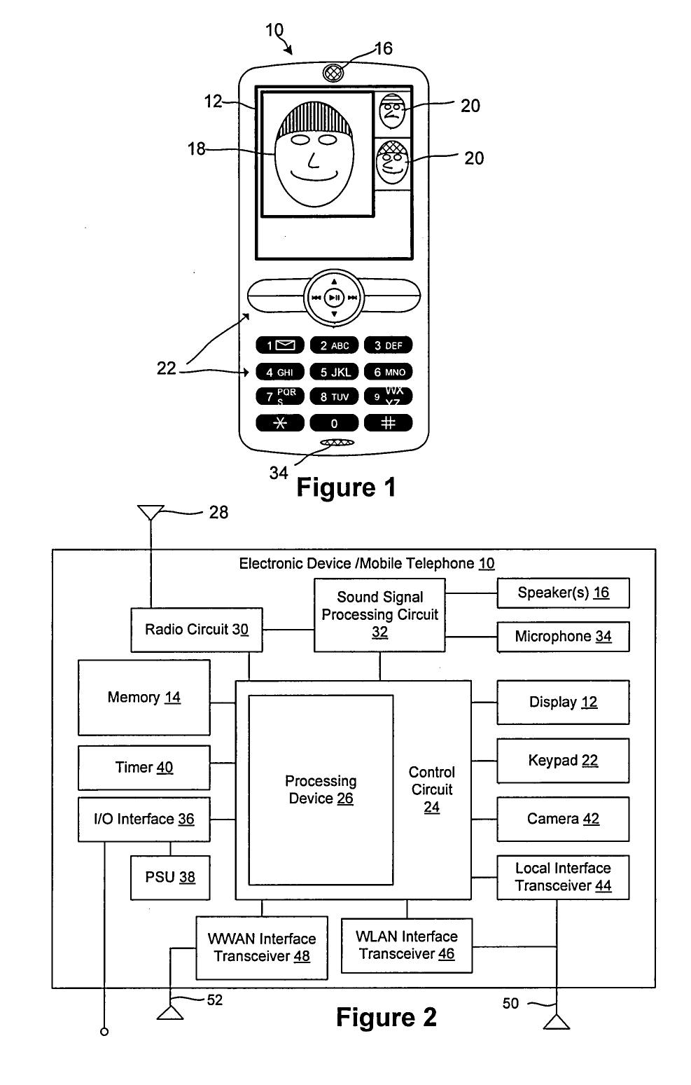

Referring to FIG. 1, an electronic device 10 (e.g., a portable communication device) is shown in accordance with aspects of the present invention. The electronic device 10 includes a display 12. The display 12 presents information to a user such as operating state, time, telephone numbers, contact information, various navigational menus, etc., which enables the user to utilize the various features of the electronic device 10. The display 12 may also be used to visually display content accessible by the electronic device 10 from one or more remote sources (e.g., a media server, a network, etc.). The displayed content may include audio and/or video presentations stored locally in memory 14 (FIG. 2) of the electronic device 10 and/or stored remotely from the electronic device (e.g., on a remote storage device, a media server, remote personal computer, etc.). The audio component may be broadcast to the user with a speaker (or speakers) 16 associated with the electronic device 10. Alternatively, the audio component may also be broadcast to the user through a speaker associated with an accessory (not shown).

As discussed in detail below, the display 12 may be used to present graphical representations of participants of a conference call. In order to facilitate identification of the participant that is speaking at any one time, one aspect of the present invention relates to displaying the participant that is currently speaking (also referred herein as the “active” participant) in a graphical representation 18 that is a larger in form than the graphical representation 20 of the participants that are not speaking (also referred to herein as “passive” or “non-active” participants), as shown in FIG. 1.

The graphical representations 18, 20 may be any desired graphical representation, for example, the graphical representation may in the form of an image, a picture, a caricature, a cartoon figure, an animated figure, a video, a text character, a symbol, a number or any symbol that may be used to distinguish one participant from another, etc. It may be desirable for the graphical representation to have at least one physical characteristic that is similar to the participant that the graphical representation is associated with. In addition, when the active participant switches from one user to another user, the graphical representation of the new active participant (e.g., the person currently speaking) may be automatically enlarged and the graphical representation of the prior active participant (now a passive participant) is reduced. In another embodiment, the graphical representation of the active participant is output in a predetermined manner. The predetermined manner includes any desirable manner, so long as the user of the electronic device is able to easily determine the active participant from the “non-active” participants.

In another embodiment, the speaker (or speakers) 16 may be stereo speakers. Each of the participants of the conference call may be assigned to a single speaker, such that all audio signals output from a particular active participant in the conference call will be output through the same speaker. If there are more participants in the session than audio output devices, more than one participant may be assigned to a particular audio output device.

The electronic device 10 further includes a keypad 22 that provides for a variety of user input operations. For example, the keypad 22 may include alphanumeric keys for allowing entry of alphanumeric information such as telephone numbers, phone lists, contact information, notes, etc. In addition, the keypad typically may include special function keys such as a “call send” key for initiating or answering a call, and a “call end” key for ending, or “hanging up” a call. Special function keys may also include menu navigation keys, for example, for navigating through a menu displayed on the display 12 to select different telephone functions, profiles, settings, etc., as is conventional. Other keys associated with the electronic device 10 may include a volume key, audio mute key, an on/off power key, a web browser launch key, a camera key, etc. Keys or key-like functionality may also be embodied as a touch screen associated with the display 12.

The electronic device 10 includes conventional call circuitry that enables the electronic device to establish a call and/or exchange signals with a called/calling device, typically another mobile telephone or landline telephone. However, the called/calling device need not be another telephone, but may be some other device such as an Internet web server, content providing server, etc. In one embodiment, the electronic device 10 is operable to establish a call session with a conference call system, as discussed below.

The electronic device 10 includes a primary control circuit 24 (also referred to herein as a “controller”) that is configured to carry out overall control of the functions and operations of the electronic device 10. For example, in the context of the present invention, the control circuit may determine the source of received audio signals received from a conference calling system. The controller can perform such functionality in a number of ways, including for example, extracting, querying and/or otherwise obtaining the unique identifier from an audio signal that was received during a multiple user communication session. The control circuit 24 may compare the unique identifier from the audio signal with participant identification information previously received from the conference calling system to identify the source of the signals. From the unique identifier, the control circuit 24 can then determine the address associated with the source of the audio signal, from information provided in the participant identification information. The control circuit 24 may then utilize the address information to determine if there exists any information associate with the active participant stored locally in the electronic device 10. The control circuit 24 may then control the display to display the graphical representation of the user that transmitted the audio signal and/or stream the received audio signals from the active participant to an assigned speaker for audible output to the user of the electronic device.

As discussed below, in order to facilitate identification of the active participant on the conference call, if a graphical representation of the active participant is stored locally, the graphical representation may be displayed. Alternatively, the electronic device may generate a graphical representation that corresponds to a user for purposes of identifying a participant. It is generally desirable to provide the graphical representation of the active participant in a form larger than graphical representations of other participants (e.g., non-participants) on the communication session and/or in a form that is distinctive of other participants in the conference call. For example, a distinctive border and/or visual effect (e.g., flashing text, flashing border, a distinctive border color, etc.) may be presented to the user of the electronic device to identify the active participant.

The control circuit 24 may include a processing device 26, such as a CPU, microcontroller or microprocessor. The processing device 26 executes code stored in a memory (not shown) within the control circuit 24 and/or in a separate memory, such as memory 14, in order to carry out conventional operation of the electronic device 10. The memory 14 may be, for example, a buffer, a flash memory, a hard drive, a removable media, a volatile memory and/or a non-volatile memory. In addition, the processing device 26 executes code to carry out various functions of the electronic device 10.

Referring to FIGS. 1 and 2, the electronic device 10 includes an antenna 28 coupled to a radio circuit 30 (e.g., GSM, 3G, 2G, etc). The radio circuit 30 includes a radio frequency transmitter and receiver for transmitting and receiving signals via the antenna 28 as is conventional. The electronic device 10 further includes a sound signal processing circuit 32 for processing the audio signal transmitted by/received from the radio circuit 30. Coupled to the sound processing circuit 32 are the speaker (or speakers) 16 and a microphone 34 that enable a user to listen and speak via the electronic device 10. The radio circuit 30 and sound processing circuit 32 are each coupled to the control circuit 24 so as to carry out overall voice operations of the electronic device 10. The control circuit 24 and sound processing circuit 32 may also be used together to control routing of audio signals of participants on a conference, so that each participant may output audio signals from one of the available speakers 16.

One of ordinary skill in the art will readily appreciate that the speaker 16 and the microphone 34 may function to allow the user to speak with and listen to an output signal from the electronic device while holding the electronic device a distance from the user. For example, the electronic device 10 may be held at arm's length from a user so that the user may watch the display 12 while participating (e.g., speak and/or listen) on a call.

The electronic device 10 also includes the aforementioned display 12 and keypad 22 coupled to the control circuit 24. The electronic device 10 further includes an I/O interface 36. The I/O interface 36 may be in the form of typical mobile telephone I/O interfaces, such as a multi-element connector at the base of the electronic device 10. As is typical, the I/O interface 36 may be used to couple the electronic device 10 to a battery charger to charge a power supply unit (PSU) 38 within the electronic device 10. In addition, or in the alternative, the I/O interface 36 may serve to connect the electronic device 10 to a wired personal hands-free adaptor, to a personal computer or other device via a data cable, etc. The electronic device 10 may also include a timer 40 for carrying out timing functions. Such functions may include timing the durations of calls, generating the content of time and date stamps, etc.

The electronic device 10 may include various built-in accessories, such as a camera 42 for taking digital pictures. Image files corresponding to the pictures may be stored in the memory 14 and/or in a removable memory (not shown). For example, the camera 42 may be used to acquire images of one or more contacts. The image may be stored with a list of contacts in memory, such that when the user is talking to the contact and/or viewing contact information associated with the contact, the image is displayed on the display 12, as graphical representation.

In one embodiment, the electronic device 10 also may include a position data receiver (not shown), such as a global positioning satellite (GPS) receiver, Galileo satellite system receiver or the like.

To establish wireless communication with other locally positioned devices, such as an accessory, another portable communication, a computer, a printer, etc., the electronic device 10 may include a local wireless interface transceiver 44, such as a Bluetooth transceiver for transmitting and receiving information to and/or from an accessory. Likewise, in order to establish communications with network-based content, the electronic device 10 may further include a wireless local area network interface transceiver 46. Preferably, the WLAN transceiver 46 is compatible with one or more IEEE 802.11 protocols (e.g., 802.11(a), 802.11(b) and/or 802.11(g), etc.) and allows the electronic device 10 to acquire a unique identifier (e.g., MAC and IP addresses) on an associated network and communicate with one or more devices on the network, assuming the user has the appropriate privileges and/or has been properly authenticated. The electronic device 10 may include a wireless wide area network (WWAN) transceiver 48 to establish communications with network-based content over a WWAN. Preferably, the WWAN transceiver 48 is compatible with one or more time division duplex protocols (e.g., (e.g., IEEE 802.16e, WiMAX, 3GPP, etc.) and allows the electronic device 10 to acquire a unique identifier (e.g., MAC and IP addresses) be uniquely identified on an associated network and communicate with one or more devices on the network, assuming the user has the appropriate privileges and/or has been properly authenticated to receive bandwidth allocations.

Local wireless interface transceiver 44 and WLAN transceiver 46 are illustrated in FIG. 2 as utilizing a common antenna 50. One of ordinary skill in the art will appreciate that the local wireless interface transceiver 44 and the WLAN transceiver 46 may utilize separate antennas. The WWAN transceiver 48 is illustrated using antenna 52 to transmit and receive WWAN information.

The electronic device 10 may be configured to operate in a wide area communications system (not illustrated). The system can include one or more servers, media gateways, and/or call control elements for managing calls placed by and destined to the electronic device 10, transmitting network-based content (e.g., image files, audio files, video files, etc.) to the electronic device 10 and carrying out any other control functions. The wide area network system may communicate with the electronic device via a network and a transmission medium. The transmission medium may include any appropriate device or assembly, including, for example, a communications tower, another mobile telephone, a wireless access point, a router, a satellite, etc. Portions of the network may include wired and/or wireless transmission pathways.

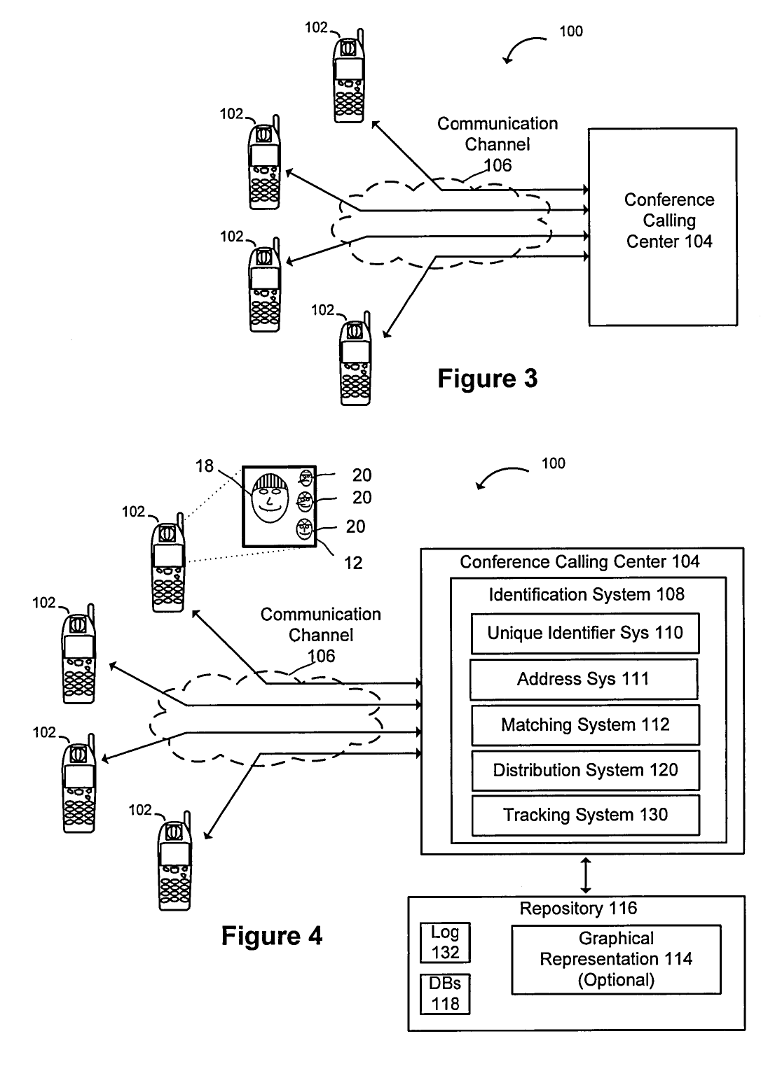

An exemplary conference calling system 100 is depicted in FIG. 3. The conference calling system 100 generally comprises a plurality of client devices 102 (e.g., electronic devices, a portable communication device, a mobile telephone, a conventional telephone, a computer, etc.) connected to a conference calling center 104 (e.g., running on a web server or other server) over a communication channel 106. Each client device 102 can be directly connected to the conference calling center 104 as shown, via a local server (not shown), or in any other suitable manner. The conference calling center 104 is responsible for forwarding all pertinent communications, voice, data, and optionally graphical representations of participants from any of the client devices 102 to any/all of the other client devices 102.

The communications channel 106 may be a telephone network, a local or wide area cellular network, the Internet, or any other communications medium, or combination thereof, over which voice data can be transmitted. Each client device 102 is operated by a user and may comprise, for example, a phone system, computer workstation, mobile telephone, etc. Although the present invention will be described with regard to the illustrative conference calling center 100 depicted in FIG. 3, it will be apparent that the present invention can be configured for use with virtually any now known or later developed conference calling system. In addition, the present invention can be applied to Voice over IP (VoIP) applications.

In accordance with an embodiment of the present invention, as shown in FIG. 4, the conference calling center 104 includes an identification system 108 for identifying participants participating in a communication session (e.g., a conference call). The identification system 108 includes a unique identifier system 110 or other identification system for assigning a unique identifier to each of the participants participating in a conference call. The unique identifier is preferably as small in size as possible in order to maximize the size audio signals transmitted from the conference calling center 104.

The identification system 108 includes an address system 111 for determining the manner in which the participants of the conference call have contacted the conference call center 104. For example, by conventional landline (phone numbers), by cellular network (phone number), by Internet (Internet Protocol address), session initiation protocol (SIP) address, short messaging service (SMS), uniform resource identifier (URI), an electronic mail address, an E.164 number, a subscriber identification module (SIM) number, etc.

The identification system includes a matching system 112 for associating the unique identifiers (unique identifier system 110) with addresses (address system 111). This can be done, for example, by using one or more databases (e.g., stored in the repository 116 and/or in the identification system 108) containing the unique identifier and address for each participant of the communication session. For example, unique identifier “1” may be assigned to moderator or the first participant that has accessed the conference calling center 104. The address associated with the unique identifier corresponds to the manner that the moderator and/or the first participant contacted the conference calling center 104. The next participant that accesses the conference calling center 104 may be assigned unique identifier “2”, for example. It is generally desirable to limit the size of the unique identifier so as not to negatively impact performance of the conference calling system 100.

Optionally, the matching system 112 may associate one or more graphical representations stored in a (secure) repository 116 (or other hard disk drive or memory location) to each user and/or unique identifier obtained by the unique identifier system 110. This can also be done, for example, using one or more databases 118 (e.g., stored in the repository 116) containing entries correlating to a unique identifier with a graphical representation 114 of the user of the client.

While the repository 116 is illustrated as being distinct from the conference calling center 104, one of ordinary skill in the art will readily appreciate that the repository 116 may be stored within the conference calling center 104.

The unique identifier may be used to tag each media packet (e.g., audio signals) transmitted to and from the conference calling center 104. Since the conference calling center 104 is aware of the client that originated the communication, the conference calling center 104 is generally responsible for appending or otherwise inserting the unique identifier to each media packet received for further transmission to the other participants of the communication session. When a media packet (e.g., an audio signal) is received at a client 102, the packet containing the audio signal and the unique identifier is queried by the control circuit 24 to identify the source of the media packet. Because, the client 102 has previously been provided with the participant identification information, the client 102 can then determine the active participant on the conference call and output the received audio signal and/or a graphical representation of the active participant in a predetermined manner.

The identification system 108 further includes a distribution system 120 for distributing the participant identification information and/or the media packets containing the unique identifier of the active participant. Such information can be distributed, for example, to an application running on the respective client devices 102 and/or processed and output in a predetermined manner.

The identification system 108 may be configured to continuously monitor the users participating in a communication session and to continuously update the distributed participant identification information. This allows for additional participants to join and/or leave the communication session. Alternatively, the identification system 108 can be configured to periodically monitor (e.g., once per minute) the users participating in the conference call and to periodically update the distributed participant identification information, as necessary.

The distribution system 120 may also distribute media packets (e.g., audio signals received by the conference calling center). Generally, the distribution center receives one or media packets from a participant. The unique identifier associated with the participant is inserted and/or appended to the media packet and distributed to the other participants of the communication session.

The identification system 108 further includes a tracking system 130. The tracking system 130 is configured to track, among other possible data, the users on a conference call (e.g., to provide a participant list), the location from which each user is calling from, and the time of participation of each user on the conference call. This data may be provided in a log 132 and stored in repository 116. The log 132 can be provided by the distribution system 120 to one or more users (e.g., to the moderator of the conference call).

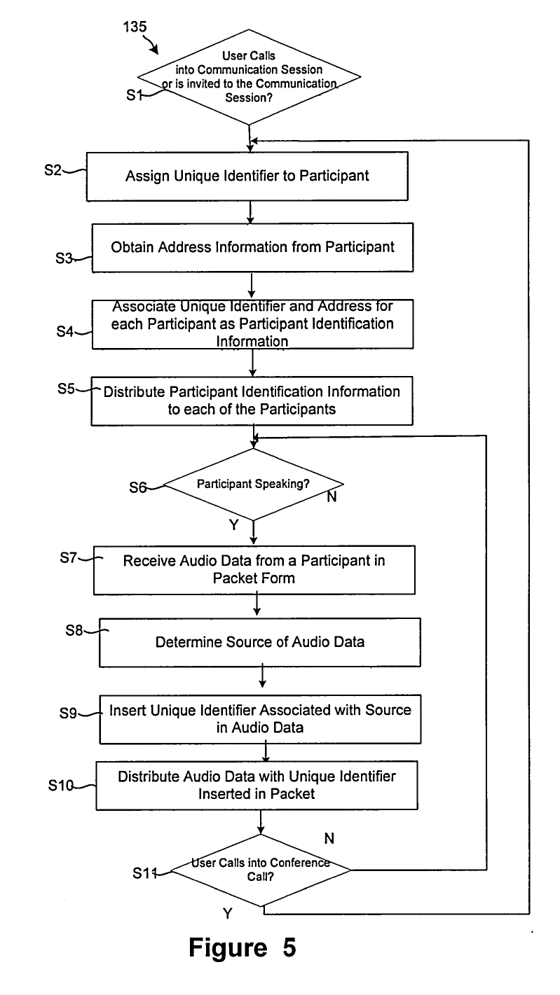

An illustrative flow diagram 135 of a process in accordance with the present invention is depicted in FIG. 5. The flow diagram 135 will be described below with reference to the system components illustrated in FIGS. 1-4.

In step S1, a user calls into a conference call (e.g., by transmitting a signal to join a conference calling system) from an electronic device. Alternatively, the conference calling system may initiate the conference call session by inviting one or more participants to join the conference call session and/or automatically add participants to the conference call session. In step S2, the identification system 22 assigns a unique identifier to the participant through unique identifier system 110. At S3, an address associated with the participant is obtained through address system 111 of the conference calling center 104. The address may be, for example, a phone number, SIP address, URI, voice information, etc.). At S4, the unique identifier and the address are associated by the matching system 112 and stored in an appropriate form (e.g., a log 132, a database 118, etc.) and location (e.g., conference calling center 104, repository 116, etc), as participant identification information. At S5, the distribution system 120 of the conference calling center 104 distributes the participant identification information to each of the participants of the communication session.

At S6, the conference calling center 104 determines whether a participant is speaking by determining whether it has received one or more media packets (e.g., audio signals) from a participant on the communication session. At S7, the one or more media packets are transmitted to from a client 102 and received by the conference calling center 100. The media packets generally include voice data associated with the user that is currently speaking (referred to herein as the “active participant”). In S8, the conference calling center 104 identifies the source of the audio signals (e.g., which conference call participant is speaking). At S9, the conference calling center 104 inserts the unique identifier associated with the active participant. At S10, the conference calling center 104 transmits the media packet of voice data with the unique identifier to non-active participants of the communication session.

The electronic devices used by the participants extract or otherwise decode the identifier to identify the active participant in the conference call. At S11, a determination is made as to whether another potential conference call participant has called into the conference call. If a new participant has called, control returns to S2 and control flows as discussed above. If at S11, there are no new potential conference call participants, control remains at S6 to determine if one of the conference call participants is speaking.

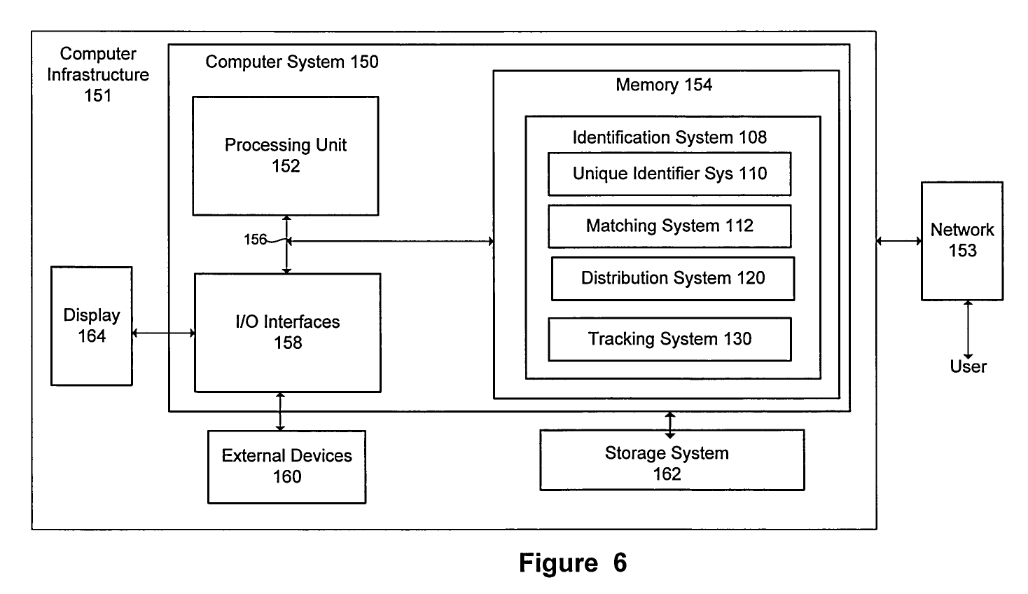

A computer system 150 for implementing a conference calling system 104 includes an identification system 108 in accordance with embodiments of the present invention as depicted in FIG. 6. Computer system 150 is provided in a computer infrastructure 151. Computer system 150 is intended to represent any type of computer system capable of carrying out the teachings of the present invention. For example, computer system 150 can be a laptop computer, a desktop computer, a workstation, a handheld device, a server, a cluster of computers, a cluster of devices, etc. In addition, as will be further described below, computer system 150 can be deployed and/or operated by a service provider that provides a service in accordance with the present invention. It should be appreciated that a user can access computer system 150 directly, or can operate a computer system that communicates with computer system 150 over a network 153 (e.g., the Internet, a wide area network (WAN), a local area network (LAN), a virtual private network (VPN), etc), cellular network, etc. In the case of the latter, communications between computer system 150 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 150 suitable for operating the conference call center 100 is illustrated in FIG. 6. The computer system 150 includes a processing unit 152, a memory 154, a bus 156, and input/output (I/O) interfaces 158. Further, computer system 150 is shown in communication with external devices/resources 160 and one or more storage systems 162. In general, processing unit 152 executes computer program code, such as identification system 108, that is stored in memory 154 and/or storage system(s) 162. While executing computer program code, processing unit 152 can read and/or write data, to/from memory 154, storage system(s) 162, and/or I/O interfaces 158. Bus 156 provides a communication link between each of the components in computer system 150. External devices/resources 160 can comprise any devices (e.g., keyboard, pointing device, display (e.g., display 164, printer, etc.) that enable the user to interact with computer system 150 and/or any devices (e.g., network card, modem, etc.) that enable computer system 150 to communicate with one or more other computing devices.

Computer infrastructure 170 is only illustrative of various types of computer infrastructures that can be used to implement the present invention. For example, in one embodiment, computer infrastructure 170 can comprise two or more computing devices (e.g., a server cluster) that communicate over a network (e.g., network 153) to perform the various process steps of the invention. Moreover, computer system 150 is only representative of the many types of computer systems that can be used in the practice of the present invention, each of which can include numerous combinations of hardware/software. For example, processing unit 152 can comprise a single processing unit, or can be distributed across one or more processing units in one or more locations, e.g., on a client and server. Similarly, memory 154 and/or storage system(s) 162 can comprise any combination of various types of data storage and/or transmission media that reside at one or more physical locations. Further, I/O interfaces 158 can comprise any system for exchanging information with one or more external devices/resources 160. Still further, it is understood that one or more additional components (e.g., system software, communication systems, cache memory, etc.) not shown in FIG. 6 can be included in computer system 150. However, if computer system 150 comprises a handheld device or the like, it is understood that one or more external devices/resources 160 (e.g., display 164) and/or one or more storage system(s) 162 can be contained within computer system 150, and not externally as shown.

Storage system(s) 162 can be any type of system (e.g., a database) capable of providing storage for information under the present invention. Such information can include, for example, databases 118, graphical representations 114, logs 132, voice keys (not shown), repository 116, etc. To this extent, storage system(s) 162 can include one or more storage devices, such as a magnetic disk drive or an optical disk drive. In another embodiment, storage system(s) 162 can include data distributed across, for example, a local area network (LAN), wide area network (WAN) or a storage area network (SAN) (not shown). Moreover, although not shown, computer systems operated by user can contain computerized components similar to those described above with regard to computer system 150.

Shown in memory 154 is an identification system 108. The identification system 108 includes a unique identifier system 110 for assigning a unique identifier to each of the participants participating in a conference call. The identification system 108 includes an address system 111 for determining the manner in which the participants of the conference call have contacted the conference call center 104 and an address for each participant. The identification system includes a matching system 112 for associating the unique identifiers (unique identifier system 110) with addresses (address system 111). This can be done, for example, by using one or more databases (e.g., stored in the repository 116 and/or in the identification system 108) containing the unique identifier and address for each participant of the communication session. For example, unique identifier “1” may be assigned to moderator or the first participant that has accessed the conference calling center 104. The address associated with the unique identifier corresponds to the manner that the moderator and/or the first participant contacted the conference calling center 104. The next participant that accesses the conference calling center 104 may be assigned unique identifier “2”, for example. It is generally desirable to limit the size of the unique identifier so as not to negatively impact performance of the conference calling system 100.

The identification system 108 also includes a distribution system 120 for distributing the participant identification information and/or the media packets containing the unique identifier of the active participant. Such information can be distributed, for example, to an application running on the respective client devices 102 and/or processed and output in a predetermined manner.

The identification system 108 further includes a tracking system 130. The tracking system 130 is configured to track, among other possible data, the users on a conference call (e.g., to provide a participant list), the location from which each user is calling from, and the time of participation of each user on the conference call.

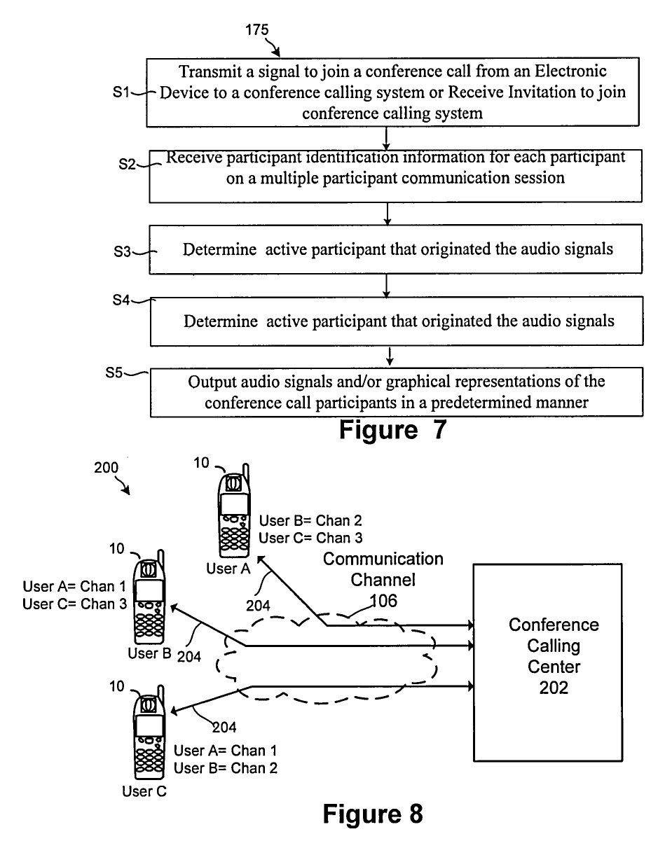

Referring to FIG. 7, an exemplary method 175 for identifying an active participant in a multiple user communication session at an electronic device is illustrated.

At S1, a signal to join a conference call is transmitted from an electronic device to a conference calling system. The signal may be any type of signal suitable to establish an audio communication link between the electronic device 10 and the conference calling system 100. Alternatively, the conference calling system may initiate the conference call session by inviting one or more participants to join the conference call session and/or automatically add participants to the conference call session.

At S2, participant identification information for each participant on the multiple participant communication session is received at the electronic device 10 from a conference calling system. The participant identification information includes a unique identifier and an address associated with each participant.

At S3, audio signals from the conference calling system are received from the conference calling system 100 at the electronic device 10. The audio signals are generally in a packet form and include identification information to identify one of the plurality of participants that originated the audio signals from the group of participants of the conference call.

At S4, the electronic device 10 identifies an active participant that originated the received audio signals based at least in part on a comparison between the unique identifier contained in the received audio signals and the participant identification information received from the conference calling system. This step is generally performed by the control circuit, but is not limited solely to performance by the control circuit.

At S5, the audio signals and/or a graphical representation of the active participant may be output in a predetermined manner based on the identification of the active participant that originated the audio signals. For example, in one embodiment, the step of outputting includes displaying a graphical representation of the active participant in a form larger than graphical representations of non-active participants of the conference call on a display associated with the electronic device. When a new active participant is identified the graphical representation associated with the prior active participant is reduced in size to correspond in size to graphical representations of non-active participants and the graphical representation of the new active participant is displayed in the form larger than graphical representations of the non-active participants.

Generally, in order to facilitate recognition of the active participant, the graphical representation of the active participant may be displayed on display 12 in a form larger than graphical representations of non-active participants of the conference call. The graphical representations are typically stored locally on the device 10. The graphical representations may be retrieved on the electronic device 10 by processing the received unique identifier from the audio signal. Once the unique identifier is determined, the address associated with the audio signal may be determined by comparing the received identifier to the received participant identification information and determining and/or looking up the corresponding address based upon the participant identification information, which may function in a similar manner as a look-up table. Once the address information of the active participant is obtained, the electronic device may be searched for contact information (e.g., graphical representations, text information, etc.) associated with the active participant. If a graphical representation of the active participant exists, the graphical representation of the active participant may be displayed on the display 12 of the electronic device. In one embodiment, the graphical representation of the active participant is displayed in a form larger than graphical representations of non-active participants of the conference call on a display 12 associated with the electronic device 10.

When a new active participant is identified the graphical representation associated with the active participant is reduced in size to correspond in size to graphical representations of non-active participants and the graphical representation of the new active participant is displayed in the form larger than graphical representations of the non-active participants.

In one embodiment, when the locally stored information associated with the active participant does not include a graphical representation of the participant, the electronic device 10 may generate a representation of the active participant. The graphical representation may be in the form of for example, an image, a picture, a caricature, a cartoon figure, an animated figure, a video, an icon, a text character, number, etc. The graphical representation may take any form that is capable of distinguishing one participant from another participant.

It may also be desirable to display identification text on a display of the electronic device when the identification text associated with a participant is stored locally in the electronic device. For example, the identification text may be is selected from contact information stored in an electronic phonebook application stored in a memory of the electronic device.

In one embodiment, each time audio signals are transmitted by the conference calling system to the electronic device, the active participant that is the source of the transmitted audio signals is identified and the graphical representation associated with the active participant is displayed in the form larger than graphical representations of the other participants on the conference call, as discussed below. In another embodiment, when a new active participant is identified the graphical representation associated with the prior active participant is reduced in size to correspond in size to graphical representations of non-active participants and the graphical representation of the new active participant is displayed in the form larger than graphical representations of the non-active participants.

In some conference calls, it may difficult to include graphical representations of all participants. Accordingly, it may desirable to only display graphical representations of participants that actively participated in the conference call.

The display 12 may present the graphical representations in any desired manner. For example, the graphical representation of the active participant may be in the center of the display with the graphical representations of the other participants positioned around one or more portions graphical representation of the active participant. In addition, the graphical representations may be displayed within a graphical window. The graphical window may also have a distinctive border. Text may also be presented adjacent to, overlaid one or more of the graphical representations. For example, the text may be identifying text that identifies the moderator and/or participant by name, nickname, etc.

In one embodiment, if the identifying text may be selected from a list of a user's contacts stored in a memory of the portable communication device. Such contacts may be stored in an electronic phonebook application, an organizer application, a calendar application, etc. Generally, the control circuit 24 may determine whether contact information regarding one or more of the participants on the conference call is stored locally in the portable communication device through identification of the unique identifier in the received audio signal and then comparing (also known as looking up) the address corresponding to the identified unique identifier in the audio signal from the participant identification information previously received by the electronic device.

In another embodiment, the step of outputting includes outputting the audio signals to an audio output device coupled to the electronic device based on the identification of the active participant that originated the audio signals. For example, if an electronic device has five speakers associated with it, each of the speakers may be associated with a participant on the conference call. If a conference call has five participants each of the participants may be assigned to one speaker. All audio signals that originated from a particular participant will be output the assigned speaker. Such a method uses audio isolation to identify the active participant of a conference call. One of ordinary skill in the art will readily appreciate if there are fewer participants than speakers associated with a particular device, some speakers may not be used. In addition, if there are more conference call participants than speakers associated with the electronic device, then multiple conference call participants may be assigned to a single speaker.

Referring to FIG. 8, an exemplary system 200 is illustrated. The system 200 includes a plurality of electronic devices 10 (e.g., User A, User B and User C) dialing into or being invited by conference calling center 202 (such as conference calling system 100 described above). A unique identifier associated with control signaling channel 204 is established between the conference calling center 202 and each client device. For example, User A may be assigned the unique identifier associated with control channel 1 (e.g., unique identifier “1”), User B may be assigned the unique identifier associated with control channel 2 (e.g., unique identifier “2”), and User C may be assigned the unique identifier associated with control channel 3 (e.g., unique identifier “3”). The control signaling channel 204 can be any type of communication protocol, including for example, SIP, SMS, landlines, or other technologies). Once the control channels are assigned, each electronic device is provided with the participant identifier information, which includes the control channel that identifies each of the other conference call participants and associated addresses as discussed above. For example, User A is provided with the unique identifier associated with User B (e.g., Channel 2) and User C (e.g., Channel 3). User B is provided with the unique identifier associated with User A (e.g., Channel 1) and User C (e.g., Channel 3). User C is provided with the unique identifier associated with User A (e.g., Channel 1) and User B (e.g., Channel 2).

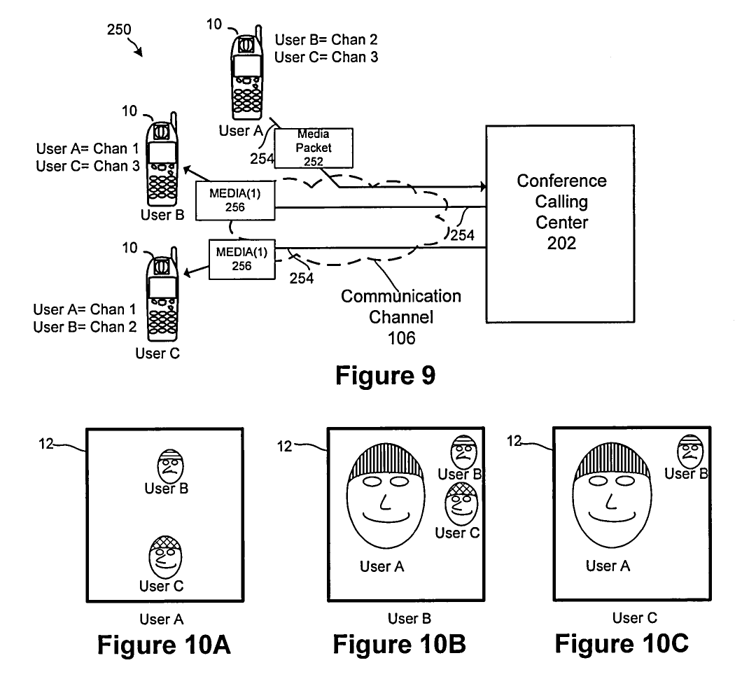

Referring to FIG. 9, an exemplary system 250 is illustrated. The system 250 includes the same electronic devices 10 as set forth above in FIG. 8. When User A begins speaking media packets 252 from the client device associated with User A are transmitted to the conference calling center 202 on a media channel 254. The media packets are received by the conference calling center 202. The conference calling center 202 tags or otherwise inserts an unique identifier associated with the user and/or client device to the packet (e.g., MEDIA (1), where 1 refers to the unique identifier associated with the source of the media packet). The media packet with the tagged identifier 256 are then transmitted to the other client devices participating on the conference call. When the tagged packet 256 is interrogated and/or received by the other client devices participating on the conference call, the other devices may identify the source of the packets as the active participant.

A graphical representation stored in the client device (e.g., a graphical representation associated with user's contacts or otherwise stored in the client device) may be displayed. Once the active participant is identified by the electronic device, the corresponding displays associated with each of the client devices may provide a graphical representation of the active participant in a graphical representation. In one embodiment, the active participant is presented in a larger form than the graphical representation of the non-active participants (e.g., those participants of the session that are not speaking), as shown in FIG. 10.

Referring to FIGS. 10A-10C, when User A is the active participant, the displays associated with User B (FIG. 10B) and User C (FIG. 10C) provide a graphical representation of User A in a larger format than the graphical representations associated with Users B and C. All or a portion of the other non-active participants may be presented in the display. For example, FIG. 10B illustrates all participants being presented on the display 12 of User B. FIG. 10C illustrates only illustrates the active participant (e.g., User A) and a non-active participant (e.g., User B). FIG. 10C, which represents User's C display does not provide a graphical representation for User C. FIG. 10A represents the display associated with the active participant (e.g., User A) and may include a graphical illustration of the active participant or the display may illustrate only the other participants on the conference call. As shown, the display in FIG. 10A only shows non-active participants on the screen associated with the active participant.

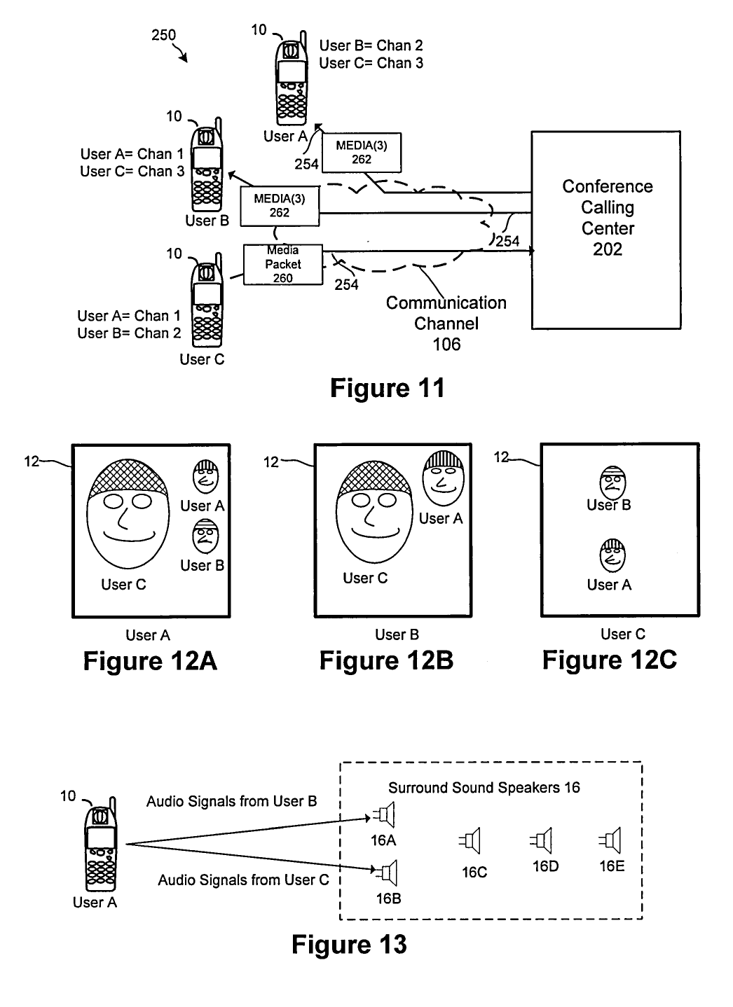

Referring to FIG. 11, when User C begins to speak, media packets 260 from the client device associated with User C are transmitted to the conference calling center 202 on a media channel 254. The media packets are received by the conference calling center 202. The conference calling center 202 tags or otherwise inserts an unique identifier associated with the user and/or client device to the packet (e.g., MEDIA (3), where 3 refers to the control channel associated with the source of the media packet). The media packets with the tagged identifier 262 are then transmitted to the other client devices participating on the conference call. When the tagged packets 262 are interrogated and/or received by the other client devices participating on the conference call, the persons speaking becomes the active participant (e.g., User C). A graphical representation stored locally in the client device (e.g., a graphical representation associated with user's contacts) may be displayed. As the active participant changes the displays associated with the client devices may provide a graphical representation of the active participant in a graphical representation that is a larger form than the graphical representation of the participants that are not speaking (e.g.,. non-active or passive participants).

Referring to FIGS. 12A-12C, the displays associated with Users A (FIG. 12A) and B (FIG. 12B) provide a graphical representation of User C (e.g., the active participant) in a larger format than the graphical representations associated with Users A and B. All or a portion of the other non-active participants may be presented in the display. For example, FIG. 12A illustrates all participants being presented on the display 12 of User A (including User A). FIG. 12B illustrates only illustrates the active participant (e.g., User C) and a non-active participant (e.g., User A). FIG. 12C, only provides a graphical representation for the non-active participants, since User C is the active participant.

Referring to FIG. 13, an electronic device 10 of User A, as discussed above with respect to FIG. 8, is illustrated coupled to a plurality of audio output devices (e.g., speakers) 16. For example, the device 10 is coupled to five speakers (16A, 16B, 16C, 16D and 16E). In addition to or in lieu of the graphical representations discussed above being used to identify the active participant on a conference call, audio signals may also be used to identify the active participant. The audio signals of each participant may be output to one of the speakers based on the identification of the active participant that originated the audio signals. For example, given the system 200 described in FIG. 8, the control circuit of User A's electronic device 10 may determine the source of received audio signals received from a conference calling system. The processor can perform this function such a number of ways, including for example, extracting, querying and/or otherwise obtaining the unique identifier associated with a conference call participant that originated the audio signal. The control circuit in conjunction with the sound processing circuit may route audio signals received from User B to speaker A, and audio signals received from User C to speaker B, for example. In this example, speakers C-E may not be used, since there are only two other participants on the conference call. As discussed above, if there are more participants than speakers, it may be desirable to associate multiple participants with a particular speaker. In another embodiment, it may be desirable for the moderator of the conference call to use a single speaker and have other participants assigned to one or more common speakers.

In the manner described above, a method and system for identifying active participants in a conference is presented. Identification information inserted in audio packets received from active participants in a conference call may be queried by an electronic device to identify the source of the audio signal. The audio signals and/or graphical representations of the active participant may be output in a predetermined manner based on the identification of the active participant that originated the audio signals.

One of ordinary skill in the art will readily appreciate that there a variety of ways to facilitate identifying an active participate. For example, graphical windows may be placed around one or more of the graphical representations. In addition, a distinctive border may be used to identify an active participant or to provide further information to the user. The graphical representations may be any desired graphical representation, for example, an image, a picture, a caricature, a cartoon figure, an animated figure, a video, etc. In one embodiment, the graphical representation has at least one physical similarity to the participant that the graphical representation is associated with. In addition, when the active participant switches from one user to another user, the graphical representation of the new active participant (e.g., the person currently speaking) automatically is enlarged and the graphical representation of the prior active participant (now a passive participant) is reduced.

The present invention can be offered as a business method on a subscription or fee basis. For example, one or more components of the present invention can be created, maintained, supported, and/or deployed by a service provider that offers the functions described herein for customers. That is, a service provider can be used to provide a service for displaying images of conference call participants, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

Although certain embodiments have been shown and described, it is understood that equivalents and modifications falling within the scope of the appended claims will occur to others who are skilled in the art upon the reading and understanding of this specification.

What is claimed is:

1. A method for identifying an active participant in a multiple participant communication session, the method comprising:
receiving participant identification information for each participant on a multiple participant communication session from a conference calling system to an electronic device, wherein the participant identification information includes an unique identifier and an address associated with each participant;
receiving an audio signal from a conference calling system, wherein the audio signal is in a packet form and includes the unique identifier associated with at least one of the plurality of participants that originated the audio signal;
identifying an active participant that originated the audio signal based at least in part on a comparison between the unique identifier contained in the audio signal and the participant identification information received from the conference calling system; and
outputting the audio signal and/or a graphical representation of the active participant in a predetermined manner based on the identification of the active participant that originated the audio signals.

2. The method of claim 1 further including processing the
received identifier from the audio signal to determine the address associated with the active participant by comparing the received identifier to the received participant identification information.

3. The method of claim 2
further including retrieving information associated with the active participant stored locally on the electronic device, wherein the information retrieved is associated with the address of the active participant.

4. The method of claim 3
further including displaying a graphical representation of the active participant when the local stored information includes graphical information associated with the active participant.

5. The method of claim 4,
wherein the step of outputting includes displaying the graphical representation of the active participant in a form larger than graphical representations of non-active participants of the conference call on a display associated with the electronic device.

6. The method of claim 5,
wherein when a new active participant is identified the graphical representation associated with the active participant is reduced in size to correspond in size to graphical representations of non-active participants and the graphical representation of the new active participant is displayed in the form larger than graphical representations of the non-active participants.

7. The method of claim 3 further including generating a representation of the active participant when local stored information does not include graphical information associated with the active participant.

8. The method of claim 1, further including displaying identification text on a display of the electronic device when the identification text associated with a participant is stored locally in the electronic device.

9. The method of claim 8, wherein the identification text is selected from contact information stored in an electronic phonebook application stored in a memory of the electronic device.

10. The method of claim 1, wherein the step of outputting includes outputting the audio signals to an audio output device coupled to the electronic device based on the identification information of the active participant contained in the received the audio signals.

11. The method of claim 10, wherein each participant participating in the multiple user communication session is assigned a separate audio output device based on the participant identification information received by the conference calling system.

12. The method of claim 1 further including receiving an invitation from the conference call center to join the conference call session.

13. The method of claim 1, wherein the electronic device transmits a request to the conference call center to join the conference call session.

14. The method of claim 1, wherein the address received in the participation identification information includes at least one from a group consisting of: an electronic mail address, a session initiation protocol (SIP) address, a uniform resource identifier (URI), an E.164 number, a telephone number, a subscriber identification module (SIM) number.

15. An electronic device comprising:
a radio for receiving participant identification information and audio signals from a conference calling center, wherein the participant identification information includes an unique identifier and an address associated with each participant of a multiple participant communication session and the audio signals correspond to at least one participant of the conference call, wherein the audio signals are in a packet form and includes the unique identifier associated with at least one of the participants that originated the audio signals;
at least one output device for outputting at least one of a graphical representation or the audio signals to an associated user of the electronic device; and
a controller coupled to the radio and the at least one output device, wherein the controller identifies an active participant of the conference call that originated the audio signal from the identification information contained in the audio signals and the controller outputs the at least one of the audio signals and/or the graphical representation of the active participant in a predetermined manner based on the identification of the active participant that originated the audio signals.

16. The electronic device of claim 15 further including a memory coupled to the controller and the at least one output device, wherein the memory includes contact information associated with one or more of the participants, wherein the contact information includes the graphical representation of at least one of the participants.

17. The electronic device of claim 16 further including a display coupled to the controller, wherein the display presents the graphical representation of the active participant in a form larger than non-active participants in the multiple participant communication session.

18. The electronic device of claim 17 further including an audio output device for outputting the audio signals received by the electronic device based on the identification information of the active participant contained in the received the audio signals.

19. The method of claim 18, wherein the audio output device includes a plurality of speakers, wherein audio signals received from the conference calling system are output to one of the plurality of speakers based on the participant identification information received by the conference calling system and the received audio signals.

20. A method for identifying an active participant in a multiple user communication session, the method comprising:
receiving a signal from each of a plurality of electronic devices, wherein each of the electronic devices is associated with a user desiring to participate in a conference call;
generating an unique identifier for each of the plurality of electronic devices;
storing an address for each of the plurality of electronic devices based on the received signal associated with each of the plurality of associated users;
associating the unique identifier with the address for each of the plurality of electronic devices;
establishing a central communication link between a conference calling center and each of the plurality of electronic devices, wherein the communication link includes a control signaling channel and a media signaling channel;
distributing participant identification information to each of the plurality of electronic devices, wherein the participant information includes the unique identifier and the address associated with each participant;
receiving a media packet from one of the associated users, wherein the media packet includes voice data associated with an active participant;
inserting the unique identifier in the media packet, wherein the unique identifier is associated with the active participant; and
transmitting the media packet containing the unique identifier to non-active participants of the multiple party communication session, wherein the unique identifier in the packet may be used to identify the active participant.
